(19) United States
(12) Patent Application Publication
(10) Pub. No.: US 2023/0403233 A1
(43) Pub. Date: Dec. 14, 2023

(54) CONGESTION NOTIFICATION IN A MULTI-QUEUE ENVIRONMENT

(71) Applicant: Intel Corporation, Santa Clara, CA (US)

(72) Inventors: Md Ashiqur RAHMAN, Portland, OR (US); Rong PAN, Saratoga, CA (US); Roberto PENARANDA CEBRIAN, Santa Clara, CA (US); Allister ALEMANIA, North Plains, OR (US); Pedro YEBENES SEGURA, San Jose, CA (US)

(21) Appl. No.: 18/239,467

(22) Filed: Aug. 29, 2023

Related U.S. Application Data
(60) Provisional application No. 63/433,736, filed on Dec. 19, 2022.

(51) Int. Cl. H04L 47/12; H04L 47/2425; H04L 47/30; H04L 49/9047

(52) U.S. Cl. CPC H04L 47/12; H04L 47/2425; H04L 47/30; H04L 49/9047

(57) ABSTRACT

Examples described herein relate to a network interface device. In some examples, the network interface device includes a host interface; a direct memory access (DMA) circuitry; a network interface; and circuitry. The circuitry can be configured to: based on received telemetry data from at least one switch: select a next hop network interface device from among multiple network interface devices based on received telemetry data. In some examples, the telemetry data is based on congestion information of a first queue associated with a first traffic class, the telemetry data is based on per-network interface device hop-level congestion states from at least one network interface device, the first queue shares bandwidth of an egress port with a second queue, the first traffic class is associated with packet traffic subject to congestion control based on utilization of the first queue, and the utilization of the first queue is based on a drain rate of the first queue and a transmit rate from the egress port.

### RELATED APPLICATION

This application claims the benefit of priority to U.S. Provisional Application No. 63/433,736, filed Dec. 19, 2022. The entire contents of that application are incorporated by reference.

### BACKGROUND

Data centers provide processing, storage, and networking resources. For example, automobiles, smart phones, laptops, tablet computers, or internet of things (IoT) devices can leverage data centers to perform data analysis, data storage, or data retrieval. Devices in data centers are connected together using high speed networking devices such as network interfaces, switches, or routers.

Networking devices utilize congestion control (CC) to attempt to reduce congestion by limiting a transmission rate of a flow and limiting outstanding unacknowledged packets. Some programmable switches can detect and propagate per-network interface device hop-level congestion states. For example, CC schemes such as High Precision Congestion Control (e.g., Li et al., “HPCC: High Precision Congestion Control,” SIGCOMM (2019)) configure switches to propagate per-hop congestion states to a sender network interface device and one or more switches.

### BRIEF DESCRIPTION OF THE DRAWINGS

FIG. 1 shows an example of allocating bandwidth to different traffic classes.

FIG. 2 depicts an example system.

FIG. 3 depicts an example process.

FIG. 4 depicts an example network interface device.

FIGS. 5A-5C depict example network interface devices.

FIG. 6 depicts an example system.

### DETAILED DESCRIPTION

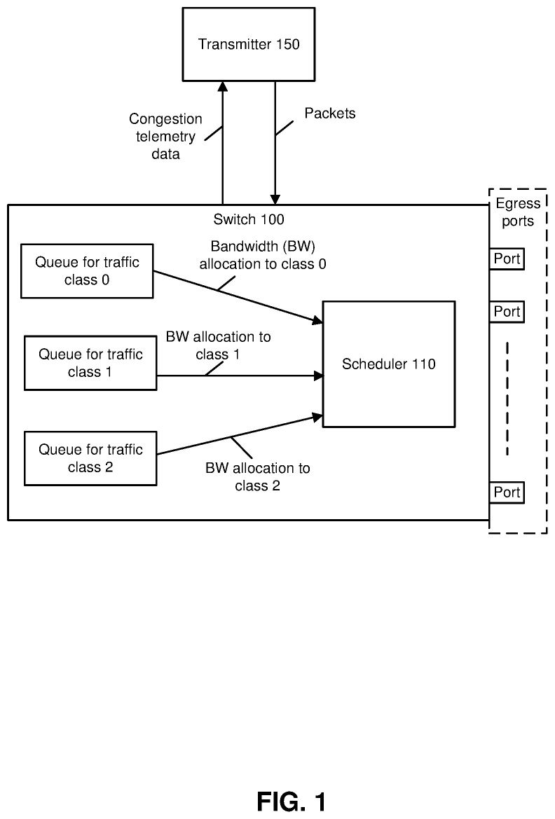

FIG. 1 shows an example of allocating bandwidth to different traffic classes 0 to 2. Scheduler 110 of switch 100 can allocate bandwidth to packets from queues for traffic classes 0 to 2. Separate queues can be allocated to traffic classes to buffer packets of a traffic class. In this example, queues 0 to 2 are allocated to packets of respective traffic classes (TCs) 0 to 2. Where a TC does not use allocated bandwidth, the bandwidth of the TC can be allocated to another TC. For example, if TC1 is allocated more than 20% of an egress port bandwidth but utilizes 20% of the available egress port bandwidth, scheduler 110 can allocate unused bandwidth to another TC (e.g., TC0 or TC2).

By use of queues for different TCs, switch 100 can provide differentiated Quality of Service (QoS) and transmit packets associated with different TCs via an egress port. However, some CC schemes presume packets of merely a single traffic class are transmitted via an egress port. For example, switch 100 provides congestion telemetry data to transmitter 150. Congestion telemetry data can represent congestion per egress port, and not per queue. For example, utilization of HPCC involves calculating congestion based on queueing in switch 100 and comparing a queue's draining rate (e.g., rate of packet egress from the queue to an egress port) against a target egress port bandwidth (BW). Where multiple queues for different traffic classes provide packets to the egress port, a draining rate of a queue may not achieve the target egress port BW, as the target egress port BW is shared by multiple queues and utilization determined based on HPCC may not accurately indicate utilization of target egress port BW.

Transmitter 150 can receive congestion telemetry data generated by switch 100 and transmitter 150 can adjust a transmit rate for a flow of packets based on the received congestion telemetry data. However, as congestion telemetry data is per-port, transmitter 150 may adjust its transmit rate without consideration that other flows also utilize the bandwidth of the egress port. In some cases, transmitter 150 may over-allocate transmit bandwidth to packets of the flow for which congestion telemetry data was reported.

Various examples described herein can provide congestion telemetry data for use in CC based on queue depth information that considers one or more other queues that utilize a same egress or output port and, potentially, based on arbiter configurations that allocate egress bandwidth from an egress port according to even or uneven weighting to different queues and associated traffic classes. According to various examples, a network interface device can calculate a utilization (U) of a traffic class and send congestion telemetry data, including the U for the traffic class, to a traffic sender network interface device as feedback. For example, the switch can determine per-queue utilization based on one or more of: outgoing or egress queue length (qlenᵢ) of class i (where i is an integer and different values of i are assigned to different traffic classes), transmission rate (txRateᵢ) for class i, or the egress bandwidth or line or port egress rate (B). Receipt of the congestion telemetry data can cause the traffic sender network interface device to maintain, reduce, or increase transmission rate for packets of class i. Accordingly, where an egress port egress packets from multiple queues for queues associated with different traffic classes and potentially different assigned bandwidth allocations (e.g., weights), a network interface device (e.g., switch) can measure utilization per traffic class and indicate such utilization in telemetry congestion data to a traffic sender network interface device.

In some examples, a network interface device can access data on an egress queue's length and can calculate utilization (U) for a traffic class i as shown in Equation (1):

$$U = \frac{{qlen}_{i}}{BDP} + \frac{{txRate}_{i}}{B} \qquad \# ( 1 )$$

where,
glen, can represent queue length,
bandwidth-delay product (BDP) can be determined based on transmit rate (txRateᵢ),
T can represent a base round-trip time (RTT) and can be calculated based on time differences between packet transmissions and indication of packet receipts, and
txRateᵢ can represent transmission rate of switch's egress queue of class i.

In some examples, a switch can determine egress queue depth, estimated per-class transmission rate, and egress port bandwidth, and indicate (1) based on a queue depth level being met or exceeded, a utilization value that is to reduce transmission rate for a traffic class i associated with the queue or (2) based on a queue depth level not being met and not exceeded, indicate a utilization value that is to cause an increase in transmit rate for the class i associated with the queue. In some examples, the switch can determine utilization of a queue based on queue occupancy levels and weights of the arbiter (or queue class weights), configured by the switch's control plane and indicate (1) based on a queue depth level being met or exceeded, a utilization value that is to reduce transmission rate for a class i associated with the queue or (2) based on a queue depth level not being met and not exceeded, indicate a utilization value to cause increase in transmit rate for the class i associated with the queue.

For example, when a traffic class shares egress port bandwidth with another traffic class, a CC scheme can reduce transmission rate of the traffic class if packets in a queue for the traffic class meet or exceed a first level and potentially reduce memory utilization for such queue at the switch. When a first traffic class shares egress port bandwidth with a second traffic class, and the first traffic class is utilizing less bandwidth of the egress port than allocated to the first traffic class and a queue associated with the second traffic class is less than the first level, the switch can indicate to one or more senders of packets of the second traffic class to increase transmission rate so that the second traffic class utilizes an increased level of egress port bandwidth. In some examples, the second traffic class is subject to CC based on HPCC, Poseidon (e.g., W. Wang, M. Moshref, Y. Li, G. Kumar, T. E. Ng, Cardwell and N. Dukkipati, “Poseidon: Efficient, Robust, and Practical Datacenter CC via Deployable INT” (2023)), or others.

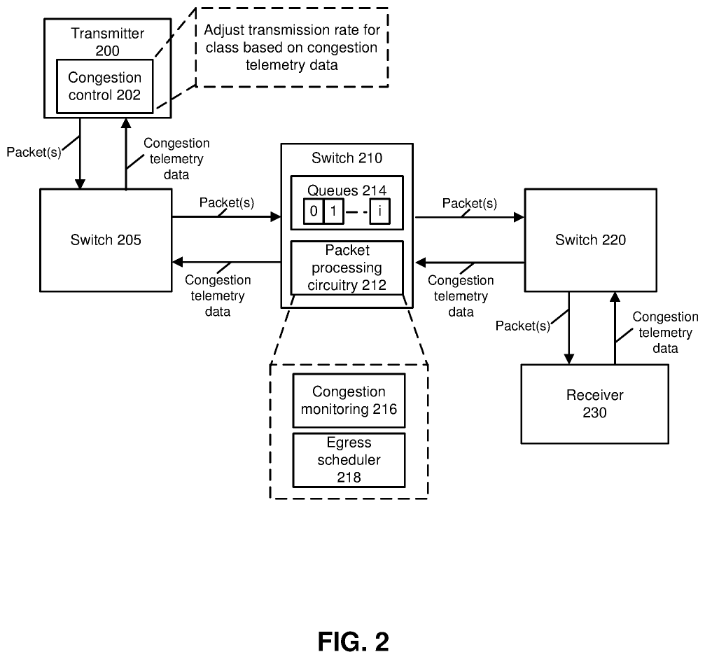

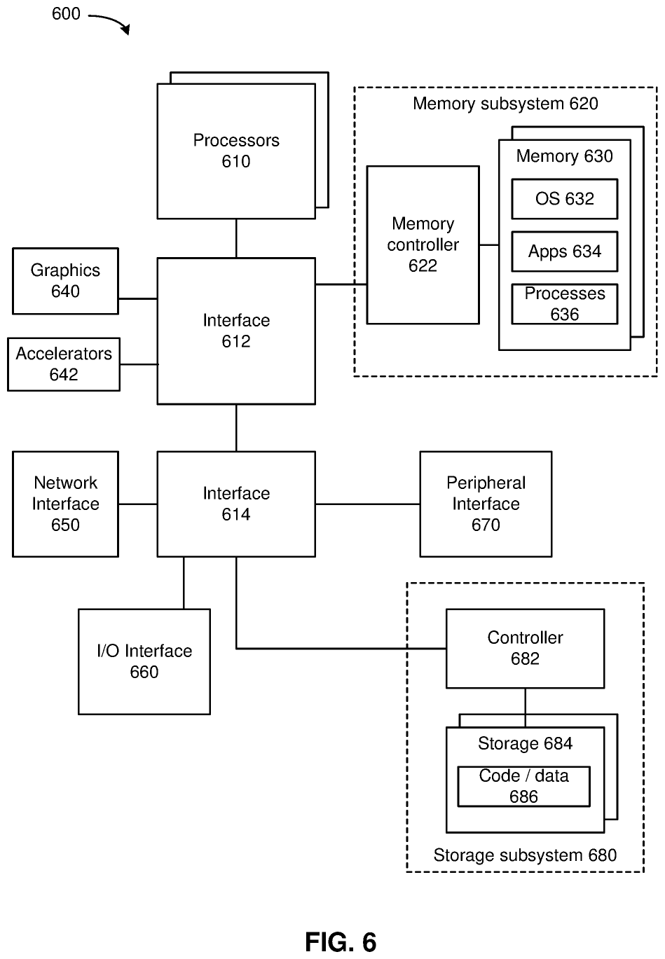

FIG. 2 depicts an example system. Transmitter 200 can transmit one or more packets to receiver 230, via one or more switches, such as switches 205, 210, and/or 220, at a request of a process or driver executed by a host system (not shown). An example of a host system is described at least with respect to FIG. 6. A packet may be used herein to refer to various formatted collections of bits that may be sent across a network, such as Ethernet frames, IP packets, Transmission Control Protocol (TCP) segments, User Datagram Protocol (UDP) datagrams, etc. References to L2, L3, L4, and L7 layers (layer 2, layer 3, layer 4, and layer 7) are references respectively to the second data link layer, the third network layer, the fourth transport layer, and the seventh application layer of the Open System Interconnection (OSI) layer model.

A flow can include a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

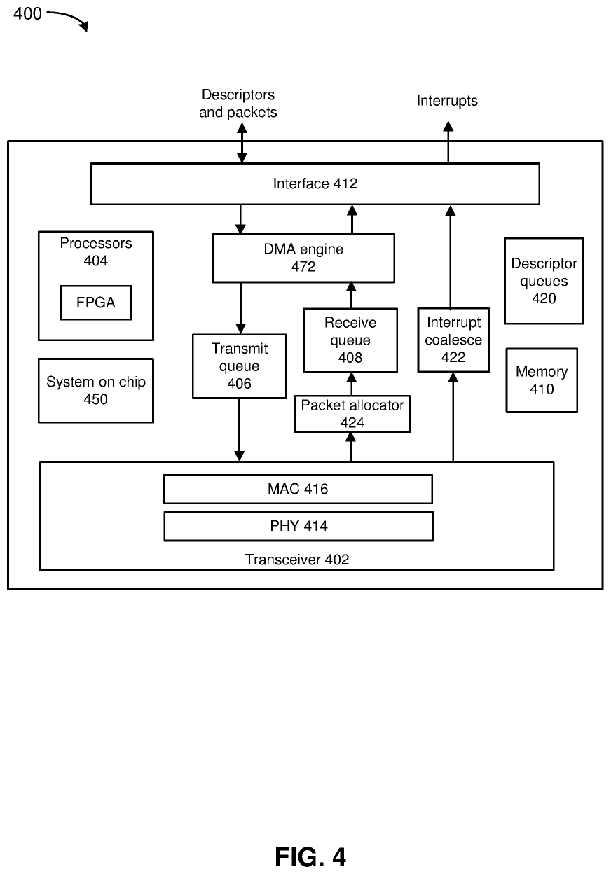

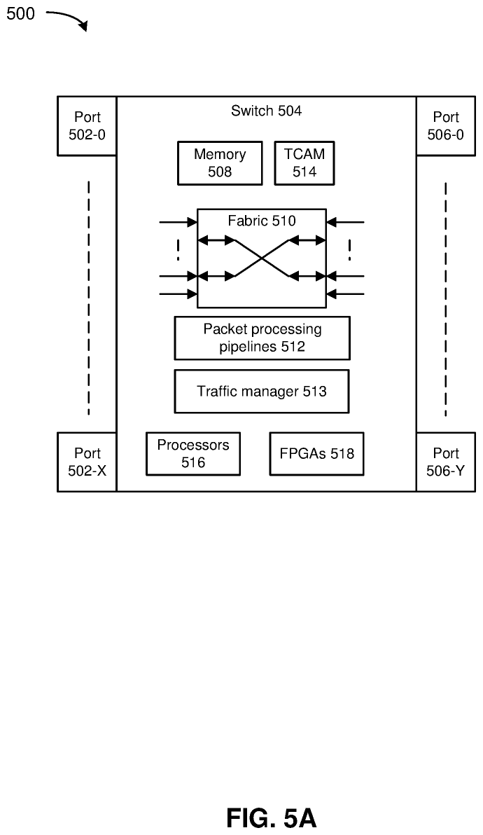

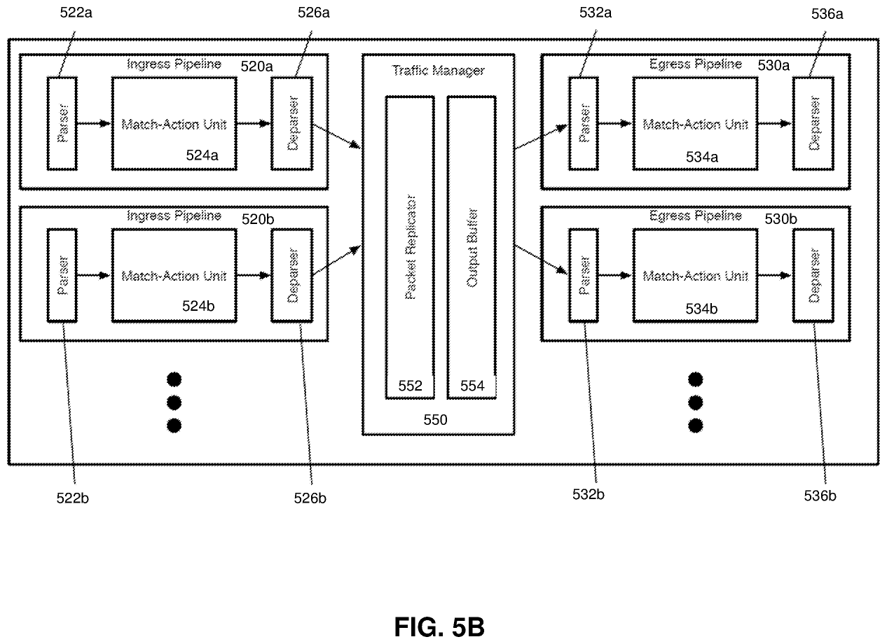

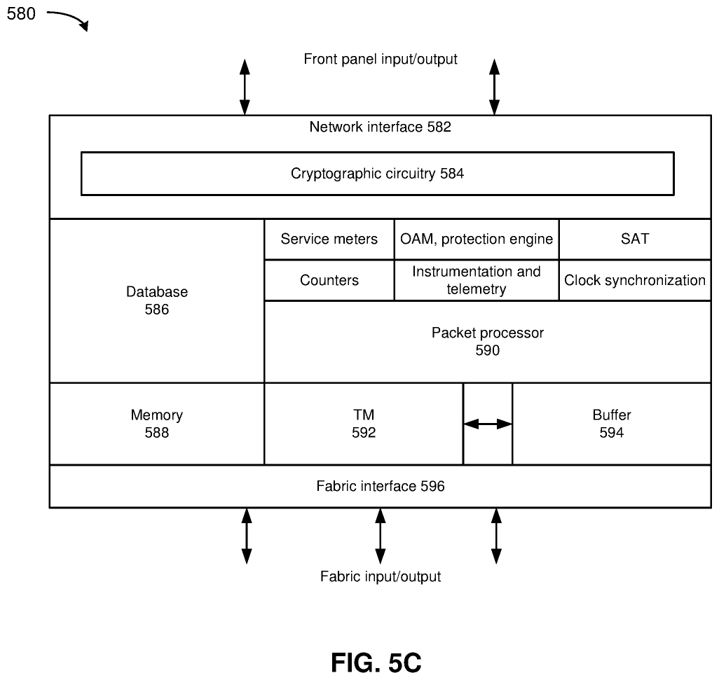

In some examples, transmitter network interface device 200, switch 205, switch 210, switch 220, and/or receiver network interface device 230 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, transmitter network interface device 200, switch 205, switch 210, switch 220, and/or receiver network interface device 230 can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, transmitter network interface device 200, switch 205, switch 210, switch 220, and/or receiver network interface device 230 can include circuitry, firmware, and/or software described with respect to FIGS. 4, 5A, 5B, 5C, and/or 6.

For example, switch 205, switch 210, and/or switch 220 can include an instance of packet processing circuitry 212. In this example, switch 210 can utilize packet processing circuitry 212 to generate utilization data or congestion telemetry data and transmit utilization data or congestion telemetry data to transmitter 200 or to receiver 230 and receiver 230 can send utilization data or congestion telemetry data to transmitter 200. However, switch 205 and/or switch 220 can perform similar operations as that of packet processing circuitry 212 to generate utilization data or congestion telemetry data and transmit utilization data or congestion telemetry data to transmitter 200 to receiver 230 and receiver 230 can send utilization data or congestion telemetry data to transmitter 200. In some examples, packet processing circuitry 212 can determine utilization data or congestion telemetry data based on an estimated transmit rate for a traffic class or transmit rate for the traffic class determined based on weight applicable to the traffic class, as described herein. In some examples, utilization data or congestion telemetry data can be measured for a traffic class that shares egress port bandwidth with at least one other traffic class. In some examples, the traffic class and/or the at least one other traffic class can be subject to congestion control based on HPCC, Poseidon, or others.

For example, queues 214 can include queues for classes 0 to i, where i is an integer, and can be allocated in memory of switch 210 (not shown) or one or more memory devices (not shown) attached via an interface to switch 210. Congestion monitoring 216 can include an egress pipeline that can access a txRateᵢ and qlenᵢ of queue class i, where txRateᵢ can represent a transmission rate for class i and glen, can represent outgoing or egress queue length for class i. Egress scheduler 218 can schedule egress of packets based on allocated bandwidth or weights applied to queues of classes 0 to i.

For example, an estimated transmit rate for a traffic class can be determined as follows. In some examples, congestion monitoring 216 can determine utilization data based on Equation (2) below.

$$U = \{ \begin{matrix}\frac{{qlen}_{i}}{{txRate}_{i} \times T} + 1 , & if {qlen}_{i} > {qlen}_{th} \\ \frac{{txRate}_{i}}{\frac{{txRate}_{i} + B}{2}} , & otherwise\end{matrix} \qquad ( 2 )$$

where, qlenₜₕ can represent a threshold level that the switch uses to restrict txRate of senders of class i, such that the total egress memory usage by class i traffic stays at or under qlenₜₕ. In some examples, glen can be specified as a number of packets or number of bytes. In some examples, qlenₜₕ can be set to 1 packet so that any packet queueing causes a slowdown in transmission rate.

If qlenᵢ>qlenₜₕ, the U can be set to be over 1, which can cause a sender (e.g., transmitter 200) to slow down a transmission of packets of class i as transmit rate can be inversely proportional to U value. Otherwise, if qlenᵢ≤qlenₜₕ, packet processing circuitry 212 can perform a binary search (e.g., average of current txRateᵢ and B (port rate)) and set U<1 to cause one or more senders (e.g., transmitter 200 and/or other transmitters) of packets of class i to increase a transmission rate for packets of class i. A binary search can estimate transmit rate of packets of class i based on utilization because it uses queue utilization for just one class (e.g., class i).

Operations of packet processing circuitry 212 to estimate transmit rate for a traffic class can be as follows in lines 2-8, described next.

| | |
|---|---|
| 1: | function calculate utilization(packet, i) |
| 2: | if packet ≠ ACK then |
| 3: | if qlenᵢ > qlenₜₕ then |
| 4: | U = qlenᵢ/(txRateᵢ × T) + 1; |
| 5: | else |
| 6: | U = txRateᵢ/((txRateᵢ + B)/2); |
| 7: | if packet.U < U then |
| 8: | packet.U = U; |

Line 2 calculates U for a received data packet and not an acknowledgement (ACK) of packet receipt. Lines 3-6 cause a switch to provide the txRateᵢ and qlenᵢ. Line 7 checks if a U value received in a packet from another switch or network interface device is less than the calculated U, and if so, line 8 updates the packet congestion telemetry data information with the higher U value from another switch or network interface device. A returning ACK packet or other packet from receiver 230 can carry this U in congestion telemetry data to transmitter 200 and transmitter 200 can adjust its txRate for class i based on HPCC or other schemes. In HPCC, a traffic sender network interface device can calculate U by utilizing ACK embedded In-band Network Telemetry (INTs) collected at one or more switches between receiver 230 and transmitter 200. Other manners of conveying congestion telemetry data are described herein.

For example, a transmit rate for a traffic class based on a weight applicable to the traffic class can be determined as follows. Packet processing circuitry 212 can access assigned weights Wᵢ and queue occupancy or length of queue of a queue class i (qlenᵢ or Qᵢ) for an egress port used to transmit packets associated to queue class i. For example, an egress pipeline in packet processing circuitry 212 can access this information through a control plane interface. Congestion monitoring 216 can determine a U for a class i based on a total weight of different queue classes saved during initialization or switch configuration. For example, total weight of different queue classes can be determined using Equation (3):

Wₜₒₜₐₗ=ΣWᵢ . . . # (3)

where, Wₜₒₜₐₗ≤100 (at most 100% of B).

For an incoming data packet at a queue i, a determination of values of Qⱼ where i≠j can be made and congestion monitoring 216 can calculate unused weights (W_{unused}) and active weights (W_{active}) as follows using Equations (4) and (5):

W_{unused}=ΣWⱼ, if Qⱼ=0 . . . # (4)

W_{active}=ΣWⱼ, if Qⱼ≠0 . . . # (5)

where,
Wᵢ can represent a percent of total egress port bandwidth allocated for class i,
Wⱼ can represent a percent of total egress port bandwidth allocated for any other class j #
W_{unused} can represent a percent of total egress port bandwidth that is not used, and
W_{active} can represent a percent of total egress port bandwidth that is used.
   Allocated weight W_{alloc} for queue i can be determined using Equation (6):

$${W}_{alloc} = \frac{{w}_{i} + {w}_{unused} \times \frac{{w}_{i}}{{w}_{active}}}{{w}_{total}} \qquad \# ( 6 )$$

Accordingly, W_{alloc} provides a percentage of line rate B utilized by packets from a queue class i. Packet processing circuitry 212 can determine U for queue i based on Equation (7):

$$U = \{ \begin{matrix}\frac{{qlen}_{i}}{{txRate}_{i} \times T} + \frac{{txRate}_{i}}{{W}_{alloc} \times B} , & if {qlen}_{i} > {qlen}_{th} \\ \frac{{txRate}_{i}}{{W}_{alloc} \times B} , & otherwise\end{matrix} \qquad \# ( 7 )$$

An example of operations of packet processing circuitry 212 to determine transmit rate for a traffic class based on weight applicable to the traffic class can be as shown in lines 1-20.

| | |
|---|---|
| 1: | Wₜₒₜₐₗ = 0 |
| 2: | for each Wᵢ in W[ ] do |
| 3: | Wₜₒₜₐₗ = Wₜₒₜₐₗ + Wᵢ; |
| 4: | function CalculateMaxUtilization (packet, i, W[ ], Q[ ]) |
| 5: | if packet ≠ ACK |
| 6: | W_{unused} = 0; |
| 7: | W_{active} = 0; |
| 8: | for each Wⱼ in W[ ] do |
| 9: | if i ≠ j then |
| 10: | if Qⱼ = 0 then |
| 11: | W_{unused} = W_{unused} + Wⱼ; |
| 12: | else |
| 13: | W_{active} = W_{active} + Wⱼ; |
| 14: | W_{alloc} = (Wᵢ + W_{unused} × Wᵢ/W_{active})/Wₜₒₜₐₗ; |
| 15: | if qlenᵢ > qlenₜₕ then |
| 16: | U = qlenᵢ/(txRateᵢ × T) + txRateᵢ/(W_{alloc} × B); |
| 17: | else |
| 18: | U = txRateᵢ/(W_{alloc} × B); |
| 19: | if packet.U < U then |
| 20: | packet.U = U; |

Lines 1-3 can perform Equation (3) to determine total weight percentages for different classes. Line 5 can check for a data packet or ACK packet. Lines 6-13 can perform Equations (4) and (5), whereas Line 14 can perform Equation (6). Lines 15-18 can perform Equation (7). Lines 19-20 check if a U value received in a packet from another switch or network interface device is less than the new calculated U, and if so, updates the packet congestion telemetry data information with the higher U value.

Receiver 230 or a switch (e.g., 220, 210, or 205) can transmit congestion telemetry data to another switch or transmitter 200 based on one or more of: In-band Network Telemetry (INT) (e.g., P4.org Applications Working Group, “In-band Network Telemetry (INT) Dataplane Specification,” Version 2.1 (2020)), Round-Trip-Time (RTT) probes, acknowledgement (ACK) of packet receipt messages sent to transmitter 200, Internet Engineering Task Force (IETF) draft-lapukhov-dataplane-probe-01, “Data-plane probe for in-band telemetry collection” (2016), IETF draft-ietf-ippm-ioam-data-09, “In-situ Operations, Administration, and Maintenance (IOAM)” (Mar. 8, 2020). In-situ Operations, Administration, and Maintenance (IOAM) can record operational and telemetry information in a packet while the packet traverses a path between two devices in the network. IOAM describes the data fields and associated data types for in-situ OAM. In-situ OAM data fields can be encapsulated into a variety of protocols such as Network Service Header (NSH) (e.g., IETF RFC 8300 (2020), Segment Routing, Geneve, IPv6 (via extension header), or IPv4.

In some examples, a switch (e.g., 220, 210, or 205) can transmit congestion telemetry data to another switch to forward to transmitter 200 so that transmitter 200 can receive congestion telemetry data prior to receipt of an ACK with congestion telemetry data from receiver 230 or instead of receipt of an ACK with congestion telemetry data from receiver 230.

In some examples, InfiniBand™ Architecture Specification Volume 1 (IBTA) reserved fields of congestion notification packets (CNPs) can be used to transmit congestion telemetry data. See, e.g., InfiniBand™ Architecture Specification Volume 1 (2007), and revisions, variations, or updates thereof. A congested point (e.g., endpoint or switch device) can send a congestion notification packet (CNP) directly or indirectly to transmitter 200 to reduce its transmit rate and alleviate congestion.

For a class i, calculating U at the switch can also enable transmitting a single, highest U value, in a single packet on the path between receiver and sender node. For a class i, a highest U along a path between transmitter 200 and receiver 230 can represent utilization of the bottleneck link, hence signaling the lowest probable txRate over the entire path. Furthermore, a U value, for a class i, can also be collected periodically through In-band Flow Analyzer (IFA) (e.g., IFA from Broadcom Inc.), e.g., each RTT, further reducing overhead of sending congestion information. Note that congestion telemetry data for multiple different traffic classes can be transmitted by one or more of switch 205, 210, and/or 220 to transmitter 200.

Transmitter 200 or its host can adjust txRateᵢ for class i based on received Uᵢ. Congestion control 202 can schedule packet transmission from multiple class queues to a network link based on a weighting, weighted deficit round robin (WDRR), weighted round robin, or others. Congestion control 202 can select a next hop network interface device from among multiple network interface devices based on received congestion telemetry data. For example, congestion control 202 can select a next hop network interface device (e.g., switch) among multiple network interface devices that is associated with a lowest received utilization (U) value or otherwise identified as being associated with a path that experiences an amount of queueing or packet drops that are equal to or less than a configured level(s). For example, congestion control 202 can select a next hop network interface device (e.g., switch) or path among multiple network interface devices or paths by increasing a weight allocated to a queue or egress port that is to provide packets to the path associated with the selected next hop network interface device or selected path. The selected next hop network interface device or selected path can be associated with a particular queue or particular egress port.

In some examples, congestion control 202 can utilize congestion telemetry data to determine bandwidth of physical paths and select physical links to aggregate based on link aggregation. Link aggregation can be based on IEEE 802.3ad (2020) and include port trunking to assign multiple physical links to a single logical link (e.g., Link Aggregation Control Protocol (LACP) based on IEEE 802.3ad (2020)).

In some examples, congestion control 202 can utilize congestion telemetry data to select links or paths to transmit packets based on MultiPath TCP (MPTCP) (e.g., Internet Engineering Task Force (IETF) Request for Comments 8684 (2020), Multipath Extension for quick UDP Internet Connections (QUIC) (e.g., QUIC Working Group, draft-ietf-quic-multipath-05 (July 2023)), Datagram Congestion Control Protocol (DCCP) Extensions for Multipath Operation with Multiple Addresses (e.g., multipath extensions to RFC4340 (2006)), Stream Control Transmission Protocol (SCTP) (e.g., IETF RFC 9260 (2022)), or others.

For some applications, the underlying transport layer is Transmission Control Protocol (TCP). Multiple different congestion control (CC) schemes can be utilized for TCP. Explicit Congestion Notification (ECN), defined in RFC 3168 (2001), allows end-to-end notification of network congestion whereby the receiver of a packet from transmitter 200 (e.g., receiver 230) echoes a congestion indication to a sender (e.g., transmitter 200). A packet sender can reduce its packet transmission rate in response to receipt of an ECN. Use of ECN can lead to packet drops if detection and response to congestion is slow or delayed. For TCP, congestion control 202 can apply congestion control based on heuristics from measures of congestion such as network latency or the number of packet drops.

Congestion control 202 can apply other TCP congestion control schemes including Google's Swift, Amazon's SRD, and Data Center TCP (DCTCP), described for example in RFC-8257 (2017). DCTCP is a TCP congestion control scheme whereby when a buffer reaches a threshold, packets are marked with ECN and the end host receives markings and sends the marked packets to a sender. Transmitter 200 can adjust its transmit rate by adjusting a congestion window (CWND) size to adjust a number of sent packets for which acknowledgement of receipt was not received. In response to an ECN, transmitter 200 can reduce a CWND size to reduce a number of sent packets for which acknowledgement of receipt was not received. Swift, SRD, DCTCP, and other CC schemes adjust CWND size based on indirect congestion metrics such as packet drops or network latency.

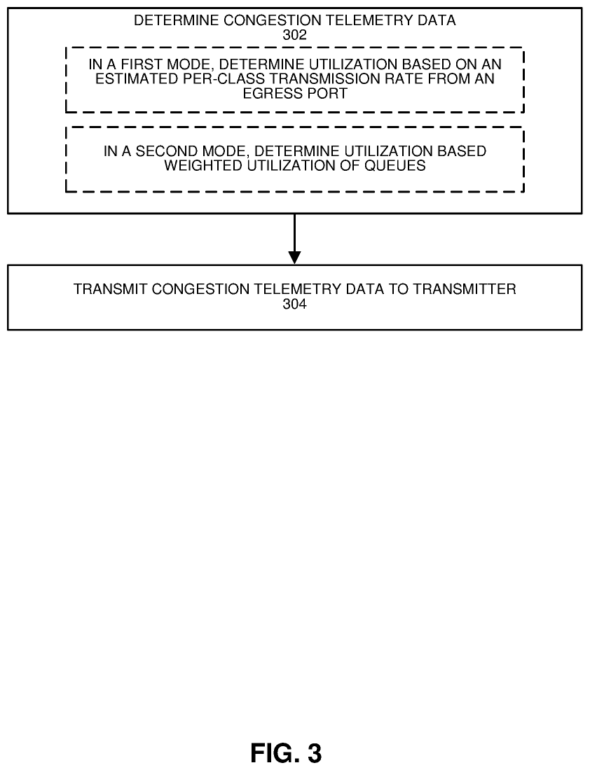

FIG. 3 depicts an example process. The process can be performed by a switch or network interface device. At 302, congestion telemetry data can be determined based on a mode of operation. An orchestrator (e.g., Kubernetes), system administrator, or device manufacturer can configure the switch or network interface device with a mode of operation. In a first mode of operation, congestion telemetry data can include utilization that can be determined based on an estimated transmit rate for a traffic class, as described herein. In a second mode of operation, congestion telemetry data can include utilization that can be determined based on weighted allocation of transmit rate to a traffic class, as described herein. For first and second modes of operation, utilization can be set to cause a decrease in packet transmission rate for a traffic class where a queue associated with the traffic class stores one or more packets. Utilization can be set to cause an increase in packet transmission rate for a traffic class where a queue associated with the traffic class stores no packet or a number of packets below a configured level.

Congestion telemetry data for multiple queues or traffic classes can be determined. In some examples, a single queue can be allocated for at least on traffic class. In some examples, multiple queues can be allocated for packets of at least one traffic class. In some examples, a single queue can be allocated to packets of multiple traffic classes.

At 304, the congestion telemetry data can be transmitted to a transmitter of packets of at least one of the traffic classes. For example, the congestion telemetry data can be transmitted using ACK packets, header fields, payload, INT, IFA, or others. Based on receipt of the congestion telemetry data, the transmitter can adjust its transmit rate or congestion window size, as described herein.

FIG. 4 depicts an example network interface device or packet processing device. In some examples, circuitry of network interface device can be utilized by the network interface or another network interface for packet transmissions and packet receipts as well as by switch circuitry described at least with respect to FIG. 5A, 5B, and/or 5C, as described herein. In some examples, packet processing device 400 can be implemented as a network interface controller, network interface card, a host fabric interface (HFI), or host bus adapter (HBA), and such examples can be interchangeable. Packet processing device 400 can be coupled to one or more servers using a bus, PCIe, CXL, or Double Data Rate (DDR). Packet processing device 400 may be embodied as part of a system-on-a-chip (SoC) that includes one or more processors, or included on a multichip package that also contains one or more processors.

Some examples of packet processing device 400 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and host interface 412, and DMA engine 452. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 414 and media access control (MAC) circuitry 416. PHY circuitry 414 can include encoding and decoding circuitry (not shown) to encode and decode data packets according to applicable physical layer specifications or standards. MAC circuitry 416 can be configured to assemble data to be transmitted into packets, that include destination and source addresses along with network control information and error detection hash values.

Processors 404 and/or system on chip 450 can include one or more of a: processor, core, graphics processing unit (GPU), field programmable gate array (FPGA), application specific integrated circuit (ASIC), or other programmable hardware device that allow programming of network interface 400. For example, a “smart network interface” can provide packet processing capabilities in the network interface using processors 404.

Processors 404 and/or system on chip 450 can include one or more packet processing pipelines that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 404 and/or system on chip 450, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

As described herein, processors 404, system on chip 450, or other circuitry can be configured to adjust a packet transmission rate or congestion window based on received congestion telemetry data.

Packet allocator 424 can provide distribution of received packets for processing by multiple CPUs or cores using timeslot allocation described herein or RSS. When packet allocator 424 uses RSS, packet allocator 424 can calculate a hash or make another determination based on contents of a received packet to determine which CPU or core is to process a packet.

Interrupt coalesce 422 can perform interrupt moderation whereby network interface interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 can provide the coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be any type of volatile or non-volatile memory device and can store any queue or instructions used to program network interface 400. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Host interface 412 can provide an interface with host device (not depicted). For example, host interface 412 can be compatible with PCI, PCI Express, PCI-x, Serial ATA, and/or USB compatible interface (although other interconnection standards may be used).

FIG. 5A depicts an example switch. Various examples can be used in or with the switch to generate congestion telemetry data, as described herein. Switch 504 can route packets or frames of any format or in accordance with any specification from any port 502-0 to 502-X to any of ports 506-0 to 506-Y (or vice versa). Any of ports 502-0 to 502-X can be connected to a network of one or more interconnected devices. Similarly, any of ports 506-0 to 506-Y can be connected to a network of one or more interconnected devices.

In some examples, switch fabric 510 can provide routing of packets from one or more ingress ports for processing prior to egress from switch 504. Switch fabric 510 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 508 can be configured to store packets received at ports prior to egress from one or more ports. Packet processing pipelines 512 can include ingress and egress packet processing circuitry to respectively process ingressed packets and packets to be egressed. Packet processing pipelines 512 can determine which port to transfer packets or frames to using a table that maps packet characteristics with an associated output port. Packet processing pipelines 512 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 512 can implement access control list (ACL) or packet drops due to queue overflow. Packet processing pipelines 512 can be configured to provide a transport layer and security protocol endpoint and perform computations on received data, as described herein. Configuration of operation of packet processing pipelines 512, including its data plane, can be programmed using P4, C, Python, Broadcom Network Programming Language (NPL), or x86 compatible executable binaries or other executable binaries. Processors 516 and FPGAs 518 can be utilized for packet processing or modification.

Traffic manager 513 can perform hierarchical scheduling and transmit rate shaping and metering of packet transmissions from one or more packet queues. Traffic manager 513 can perform congestion management such as flow control, congestion notification message (CNM) generation and reception, priority flow control (PFC), and others.

FIG. 5B depicts an example network forwarding system that can be used as a network interface device or router. Forwarding system can generate congestion telemetry data, as described herein. For example, FIG. 5B illustrates several ingress pipelines 520, a traffic management unit (referred to as a traffic manager) 550, and several egress pipelines 530. Though shown as separate structures, in some examples the ingress pipelines 520 and the egress pipelines 530 can use the same circuitry resources. In some examples, egress pipelines 530 can perform operations of a collective unit circuitry, as described herein.

Operation of pipelines can be programmed using Programming Protocol-independent Packet Processors (P4), C, Python, Broadcom NPL, or x86 compatible executable binaries or other executable binaries. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

In some examples, in response to receiving a packet, the packet is directed to one of the ingress pipelines 520 where an ingress pipeline may correspond to one or more ports of a hardware forwarding element. After passing through the selected ingress pipeline 520, the packet is sent to the traffic manager 550, where the packet is enqueued and placed in the output buffer 554. In some examples, the ingress pipeline 520 that processes the packet specifies into which queue the packet is to be placed by the traffic manager 550 (e.g., based on the destination of the packet or a flow identifier of the packet). The traffic manager 550 then dispatches the packet to the appropriate egress pipeline 530 where an egress pipeline may correspond to one or more ports of the forwarding element. In some examples, there is no necessary correlation between which of the ingress pipelines 520 processes a packet and to which of the egress pipelines 530 the traffic manager 550 dispatches the packet. That is, a packet might be initially processed by ingress pipeline 520b after receipt through a first port, and then subsequently by egress pipeline 530a to be sent out a second port, etc.

A least one ingress pipeline 520 includes a parser 522, a chain of multiple match-action units or circuitry (MAUs) 524, and a deparser 526. Similarly, egress pipeline 530 can include a parser 532, a chain of MAUs 534, and a deparser 536. The parser 522 or 532, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 522 or 532 separates out the packet headers (up to a designated point) from the payload of the packet, and sends the payload (or the entire packet, including the headers and payload) directly to the deparser without passing through the MAU processing. Egress parser 532 can use additional metadata provided by the ingress pipeline to simplify its processing.

MAUs 524 or 534 can perform processing on the packet data. In some examples, the MAUs includes a sequence of stages, with each stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, MAU(s) can provide a transport layer and security protocol endpoint and perform computations on received data, as described herein.

Deparser 526 or 536 can reconstruct the packet using the PHV as modified by the MAU 524 or 534 and the payload received directly from the parser 522 or 532. The deparser can construct a packet that can be sent out over the physical network, or to the traffic manager 550. In some examples, the deparser can construct this packet based on data received along with the PHV that specifies the protocols to include in the packet header, as well as its own stored list of data container locations for each possible protocol's header fields.

Traffic manager (TM) 550 can include a packet replicator 552 and output buffer 554. In some examples, the traffic manager 550 may include other components, such as a feedback generator for sending signals regarding output port failures, a series of queues and schedulers for these queues, queue state analysis components, as well as additional components. Packet replicator 552 of some examples performs replication for broadcast/multicast packets, generating multiple packets to be added to the output buffer (e.g., to be distributed to different egress pipelines).

Output buffer 554 can be part of a queuing and buffering system of the traffic manager in some examples. The traffic manager 550 can provide a shared buffer that accommodates any queuing delays in the egress pipelines. In some examples, this shared output buffer 554 can store packet data, while references (e.g., pointers) to that packet data are kept in different queues for each egress pipeline 530. The egress pipelines can request their respective data from the common data buffer using a queuing policy that is control-plane configurable. When a packet data reference reaches the head of its queue and is scheduled for dequeuing, the corresponding packet data can be read out of the output buffer 554 and into the corresponding egress pipeline 530.

FIG. 5C depicts an example switch. Various examples can be used in or with the switch to generate congestion telemetry data, as described herein. Switch 580 can include a network interface 582 that can provide an Ethernet consistent interface. Network interface 582 can support 25 GbE, 50 GbE, 100 GbE, 200 GbE, 400 GbE Ethernet port interfaces. Cryptographic circuitry 584 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 586 can store a device's profile to configure operations of switch 580. Memory 588 can include High Bandwidth Memory (HBM) for packet buffering. Packet processor 590 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 590 can include one or more FPGAs. Buffer 594 can store one or more packets. Traffic manager (TM) 592 can provide per-subscriber bandwidth guarantees in accordance with service level agreements (SLAs) as well as performing hierarchical quality of service (QoS). Fabric interface 596 can include a serializer/de-serializer (SerDes) and provide an interface to a switch fabric.

Operations of components of switches of examples of devices of FIG. 4, 5A, 5B, and/or can be combined and components of the switches of examples of FIG. 4, 5A, 5B, and/or 5C can be included in other examples of switches of examples of FIG. 4, 5A, 5B, and/or 5C. For example, components of examples of switches of FIG. 4, 5A, 5B, and/or 5C can be implemented in a switch system on chip (SoC) that includes at least one interface to other circuitry in a switch system. A switch SoC can be coupled to other devices in a switch system such as ingress or egress ports, memory devices, or host interface circuitry.

FIG. 6 depicts a system. In some examples, circuitry of system 600 can configure network interface device 650 to generate and transmit congestion telemetry data, as described herein. In some examples, circuitry of network interface device 650 can be utilized to adjust packet transmission rate or congestion window size and/or generate congestion telemetry data, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can configure network interface 650 to adjust packet transmission rate or congestion window size and/or generate and transmit congestion telemetry data, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNlC, router, switch, forwarding element, infrastructure processing unit (IPU), or data processing unit (DPU). An example IPU or DPU is described with respect to FIG. 4, 5A, 5B, and/or 5C.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes a network interface device comprising: a host interface; a direct memory access (DMA) circuitry; a network interface; and circuitry to: based on received telemetry data from at least one switch: select a next hop network interface device from among multiple network interface devices based on received telemetry data, wherein: the telemetry data is based on congestion information of a first queue associated with a first traffic class, the telemetry data is based on per-network interface device hop-level congestion states from at least one network interface device, the first queue shares bandwidth of an egress port with a second queue, the first traffic class is associated with packet traffic subject to congestion control based on utilization of the first queue, and the utilization of the first queue is based on a drain rate of the first queue and a transmit rate from the egress port; and cause transmission of a packet to the selected next hop network interface device.

Example 2 includes one or more examples, wherein the congestion control based on utilization of the first queue is based on one or more of: High Precision Congestion Control (HPCC) or Poseidon.

Example 3 includes one or more examples, wherein the select a next hop network interface device from among multiple network interface devices based on received telemetry data comprises select a next hop network interface device from among multiple network interface devices based on a utilization level or a packet drop level.

Example 4 includes one or more examples, wherein the select a next hop network interface device from among multiple network interface devices based on received telemetry data comprises adjust a weight allocated to a queue or egress port that is to provide packets to the selected next hop network interface device.

Example 5 includes one or more examples, and includes an apparatus that includes a switch circuitry comprising: at least one network interface and circuitry to: based on sharing of bandwidth of an egress port between a first traffic class, subject to congestion control based on utilization of a first queue associated with the first traffic class, and a second traffic class: based on a first level of the first queue associated with the first traffic class, cause a reduction in packet transmission rate of the first traffic class, wherein the utilization of the first queue is based on a drain rate of the first queue and a transmit rate from the egress port and based on a second level of the first queue and the second traffic class having available shared bandwidth, cause an increase in packet transmission rate of packets of the first traffic class, wherein the first level of the first queue is higher than the second level of the first queue.

Example 6 includes one or more examples, wherein the congestion control is based on one or more of: High Precision Congestion Control (HPCC) or Poseidon.

Example 7 includes one or more examples, wherein the first level comprises a congested state of the first queue.

Example 8 includes one or more examples, wherein the second level comprises a non-congested state of the first queue.

Example 9 includes one or more examples, wherein the circuitry is to determine the utilization of the first queue based on a depth of the first queue.

Example 10 includes one or more examples, wherein the circuitry is to determine the utilization of the first queue based on a percentage of line rate utilized by packets transmitted from the first queue.

Example 11 includes one or more examples, and includes a method that includes: at a switch: based on sharing of bandwidth of an egress port between a first traffic class, subject to congestion control based on utilization of a first queue, and a second traffic class: based on a first level of the first queue associated with the first traffic class, causing a reduction in packet transmission rate of the first traffic class, wherein the utilization of the first queue is based on a drain rate of the first queue and a transmit rate from the egress port and based on a second level of the first queue and the second traffic class having available shared bandwidth, causing an increase in packet transmission rate of packets of the first traffic class, wherein the first level of the first queue is higher than the second level of the first queue.

Example 12 includes one or more examples, wherein the congestion control is based on one or more of: High Precision Congestion Control (HPCC) or Poseidon.

Example 13 includes one or more examples, wherein the first level comprises a congested state of the first queue.

Example 14 includes one or more examples, wherein the second level comprises a non-congested state of the first queue.

Example 15 includes one or more examples, and includes determining the utilization of the first queue based on a depth of the first queue.

Example 16 includes one or more examples, and includes determining the utilization of the first queue based on a percentage of line rate utilized by packets transmitted from the first queue.

Example 17 includes one or more examples, and includes a method that includes: at a switch: based on received telemetry data from at least one switch: selecting a next hop network interface device from among multiple network interface devices based on the received telemetry data, wherein: the telemetry data is based on congestion information of a first queue associated with a first traffic class, the telemetry data is based on per-network interface device hop-level congestion states from at least one network interface device, the first queue shares bandwidth of an egress port with a second queue, the first traffic class is associated with packet traffic subject to congestion control based on utilization of the first queue, and the utilization of the first queue is based on a drain rate of the first queue and a transmit rate from the egress port; and causing transmission of a packet to the selected next hop network interface device.

Example 18 includes one or more examples, wherein the congestion control based on utilization of the first queue is based on one or more of: High Precision Congestion Control (HPCC) or Poseidon.

Example 19 includes one or more examples, wherein the selecting a next hop network interface device from among multiple network interface devices based on the received telemetry data comprises adjust a weight allocated to a path among multiple paths to a destination receiver.

Example 20 includes one or more examples, and includes adjusting a transmission rate of packets of the first traffic class based on the telemetry data.

1. An apparatus comprising:
a network interface device comprising:
a host interface;
a direct memory access (DMA) circuitry;
a network interface; and
circuitry to:
based on received telemetry data from at least one switch:
select a next hop network interface device from among multiple network interface devices based on received telemetry data, wherein:
the telemetry data is based on congestion information of a first queue associated with a first traffic class,
the telemetry data is based on per-network interface device hop-level congestion states from at least one network interface device,
the first queue shares bandwidth of an egress port with a second queue,
the first traffic class is associated with packet traffic subject to congestion control based on utilization of the first queue, and
the utilization of the first queue is based on a drain rate of the first queue and a transmit rate from the egress port; and
cause transmission of a packet to the selected next hop network interface device.

2. The apparatus of claim 1, wherein the congestion control based on utilization of the first queue is based on one or more of: High Precision Congestion Control (HPCC) or Poseidon.

3. The apparatus of claim 1, wherein the select a next hop network interface device from among multiple network interface devices based on received telemetry data comprises select a next hop network interface device from among multiple network interface devices based on a utilization level or a packet drop level.

4. The apparatus of claim 1, wherein the select a next hop network interface device from among multiple network interface devices based on received telemetry data comprises adjust a weight allocated to a queue or egress port that is to provide packets to the selected next hop network interface device.

5. An apparatus comprising:
a switch circuitry comprising:
at least one network interface and
circuitry to:
based on sharing of bandwidth of an egress port between a first traffic class, subject to congestion control based on utilization of a first queue associated with the first traffic class, and a second traffic class:
based on a first level of the first queue associated with the first traffic class, cause a reduction in packet transmission rate of the first traffic class, wherein the utilization of the first queue is based on a drain rate of the first queue and a transmit rate from the egress port and
based on a second level of the first queue and the second traffic class having available shared bandwidth, cause an increase in packet transmission rate of packets of the first traffic class, wherein the first level of the first queue is higher than the second level of the first queue.

6. The apparatus of claim 5, wherein the congestion control is based on one or more of: High Precision Congestion Control (HPCC) or Poseidon.

7. The apparatus of claim 5, wherein the first level comprises a congested state of the first queue.

8. The apparatus of claim 5, wherein the second level comprises a non-congested state of the first queue.

9. The apparatus of claim 5, wherein the circuitry is to determine the utilization of the first queue based on a depth of the first queue.

10. The apparatus of claim 5, wherein the circuitry is to determine the utilization of the first queue based on a percentage of line rate utilized by packets transmitted from the first queue.

11. A method comprising:
at a switch:
based on sharing of bandwidth of an egress port between a first traffic class, subject to congestion control based on utilization of a first queue, and a second traffic class:
based on a first level of the first queue associated with the first traffic class, causing a reduction in packet transmission rate of the first traffic class, wherein the utilization of the first queue is based on a drain rate of the first queue and a transmit rate from the egress port and
based on a second level of the first queue and the second traffic class having available shared bandwidth, causing an increase in packet transmission rate of packets of the first traffic class, wherein the first level of the first queue is higher than the second level of the first queue.

12. The method of claim 11, wherein the congestion control is based on one or more of: High Precision Congestion Control (HPCC) or Poseidon.

13. The method of claim 11, wherein the first level comprises a congested state of the first queue.

14. The method of claim 11, wherein the second level comprises a non-congested state of the first queue.

15. The method of claim 11, comprising: determining the utilization of the first queue based on a depth of the first queue.

16. The method of claim 11, comprising: determining the utilization of the first queue based on a percentage of line rate utilized by packets transmitted from the first queue.

17. A method comprising:
at a switch:
based on received telemetry data from at least one switch:
selecting a next hop network interface device from among multiple network interface devices based on the received telemetry data, wherein:
the telemetry data is based on congestion information of a first queue associated with a first traffic class,
the telemetry data is based on per-network interface device hop-level congestion states from at least one network interface device,
the first queue shares bandwidth of an egress port with a second queue,
the first traffic class is associated with packet traffic subject to congestion control based on utilization of the first queue, and
the utilization of the first queue is based on a drain rate of the first queue and a transmit rate from the egress port; and
causing transmission of a packet to the selected next hop network interface device.

18. The method of claim 17, wherein the congestion control based on utilization of the first queue is based on one or more of: High Precision Congestion Control (HPCC) or Poseidon.

19. The method of claim 17, wherein the selecting a next hop network interface device from among multiple network interface devices based on the received telemetry data comprises adjust a weight allocated to a path among multiple paths to a destination receiver.

20. The method of claim 17, comprising:
adjusting a transmission rate of packets of the first traffic class based on the telemetry data.
